(19) United States
(12) Patent Application Publication
(10) Pub. No.: US 2017/0113429 A1
(43) Pub. Date: Apr. 27, 2017

(54) FEATURE MOLDING INTO FABRICS

(71) Applicant: Dawn POLS, Wayne, NJ (US)

(72) Inventor: Dawn POLS, Wayne, NJ (US)

(21) Appl. No.: 15/398,400

(22) Filed: Jan. 4, 2017

Related U.S. Application Data
(63) Continuation-in-part of application No. 14/789,276, filed on Jul. 1, 2015.
(60) Provisional application No. 62/019,464, filed on Jul. 1, 2014.

(51) Int. Cl. B29D 99/00; A41D 1/06; A41B 9/00; A41D 19/00; A42B 1/24; B29D 19/00; A41B 1/08; A44B 18/00; A44B 17/00; A44B 1/18; A44B 13/00; A41B 11/00; A41B 13/00

(52) U.S. Cl. CPC B29D 99/0064; A41B 11/002; A41D 1/06; A41B 9/00; A41D 19/0037; A42B 1/24; A41B 13/00; A41B 1/08; A44B 18/0069; A44B 18/0073; A44B 17/0064; A44B 1/18; A44B 13/0029; A44B 17/0041; A44B 18/0049; B29D 19/00; B29K 2101/12

(57) ABSTRACT

A fastening mechanism that is integrated with the material of an article of clothing is described. The article of clothing, preferably a sock or glove, is treated with a chemical agent and a press to form a fastening mechanism for holding or coupling of multiple articles of clothing or manufacture. The fastening mechanism of one article of clothing can then be matched to an interlocking fastening mechanism of another article of clothing thereby joining the two articles of clothing together. The chemical agent and subsequent fastening mechanism is generally desired to be non-reactive and is preferably resistant to water and heat. This allows the article of clothing to be worn and washed as normal without a loss of functionality.

### CLAIM OF PRIORITY

This application claims priority to U.S. application Ser. No. 14/789,276 filed on Jul. 1, 2015 and U.S. Application 62/019,464 filed on Jul. 1, 2014, the contents of both of which are herein fully incorporated by reference in its entirety.

### FIELD OF THE EMBODIMENTS

The field of the embodiments of the present invention relate to articles of clothing and other objects comprising layer(s) of material such as fabrics. The present invention generally relates to an apparatus for securing or holding at least a first item to a second item. In particular, the apparatus may be formed from the material itself or by a chemical agent that permeates and integrates with the item, solidifying, and thereby allowing various items to be secured to one another.

### BACKGROUND OF THE INVENTION

Articles of clothing and other items are typically adhered and secured via any number of snaps, clasps, loops, button, zippers, hook and loop fasteners, and the like. At times, these fastening mechanisms are used to help keep track of various articles when they are not being used. For example, mittens can be secured to one another so one does not lose one of the mittens during their endeavors or storage. Further, toys or plush animals or the like may be coupled to one another for the same reasons. Some of the various articles that employ various fastening mechanisms lack a sufficient mechanism of securement whereas others use their mechanisms for primarily fashion purposes.

For example, socks are designed to be worn in pairs, yet there is no suitable mechanism for which socks can be attached or otherwise coupled to one another. Some people combat this lack of unity by holding a pair of socks side by side and rolling the top cuff downwards. The rolled fabric holds the pair of socks together, but can result in a stretching of the fabric and socks that no longer fit the wearer. Yet others have attempted to rectify this situation by placing fastening mechanisms on the socks. However, this causes a new set of problems.

Traditional snaps, fasteners, and the like are stiff and uncomfortable. The inclusion of these mechanisms on socks, which are worn for comfort, can be quite irritating to many. Additionally, such mechanisms can be unsightly. Further, depending on the style of sock, there may be no suitable location for such a mechanism to be attached to the sock without interfering with worn shoes.

In other instances, snaps and clasps and the like, may become separated from their original item. This may result in loose snaps and articles that may no longer be coupled to one another. If the snap was on a child's toy, this may become a choking hazard that could cause serious injury or death. In other instances, it may render an article of clothing, such as pants, unwearable.

Thus, there needs to be a fastening mechanism that can be used without causing undue interference or irritation to a wearer. Further, such a mechanism can be employed to prevent socks from being lost or ending up in mismatched pairs. Even yet, such fastening mechanisms should be firmly coupled to the article to prevent undue separation of the mechanism from the article. The present invention and its embodiments meets and exceeds these objectives.

### Review of Related Technology:

U.S. Pat. No. 7,058,986 pertains to a sock with a cuff having an inner fabric layer and an outer fabric layer folded over at least a portion of the inner fabric layer. A snap fastener is secured to the inner fabric layer. A slit or opening extends through the outer fabric layer to expose the snap fastener so that it can removably engage a complementary snap fastener on a second sock.

U.S. Pat. No. 7,065,794 pertains to a necktie that is removably attachable to a button-down shirt of the type having a row of buttons disposed down the front thereof so as to prevent said necktie from moving out of place, said necktie comprising a single elongated article of clothing having a wide end having front and rear surfaces and a narrow end having front and rear surfaces, wherein a row of buttonholes is provided on said rear surface of said wide end and a corresponding first attachment button is provided on said front surface of said narrow end to attach said wide end to said narrow end such that said first attachment means is not visible on said front surface of said wide end, and wherein second row of buttonholes is provided on said rear surface of said narrow end to attach said rear surface of said narrow end to said row of buttons.

U.S. Pat. No. 6,185,571 pertains to a device for attaching articles of clothing together. The present invention utilizes paired fasteners on each of the two articles of clothing to be attached together. This allows the two articles to either be attached together or turned inside out and folded upon themselves and attached to themselves. In this folded-down state, the fasteners are hidden from view.

Various devices are known in the art. However, their structure and means of operation are substantially different from the present disclosure. They do not provide for fastening mechanisms formed from the fabric material or for fastening mechanisms that permeate through a fabric layer. The other inventions fail to solve all the problems taught by the present disclosure. At least one embodiment of this invention is presented in the drawings below and will be described in more detail herein.

### SUMMARY OF THE INVENTION

Generally, the present invention provides for a fastening mechanism which may be formed from at least one layer of fabric, such as a woven or non-woven fabric, or from a material that permeates the layer of fabric without causing a loss in structural integrity to the material. To achieve such means, at least a first and a second fastening mechanism should be formed according to the descriptions contained herein. The first and the second fastening mechanisms should be complementary in shape to allow the mechanisms to couple to one another.

The chemical agent employed should be safe for use and be non-reactive with the fabric or other material in question. Additionally, it is desirable that such an agent be heat resistant, water insoluble or water resistant, and form a fastening mechanism that is comfortable yet discreet.

In one embodiment of the present invention there is a fastening system having a first layer having at least one first fastening mechanism, wherein the at least one first fastening mechanism comprises a first patch of the first surface, wherein the first patch is treated with a chemical agent causing the at least one first fastening mechanism to be formed from the first layer; and a second layer having at least one second fastening mechanism, wherein the at least one second fastening mechanism comprises a second patch of the second layer, wherein the second patch is treated with the chemical agent causing the at least one second fastening mechanism to be formed from the second layer; and wherein the at least one first fastening mechanism has a shape that is complementary to a shape of the at least one second fastening mechanism.

In another embodiment there is a fastening system having a first layer having at least one first fastening mechanism, wherein the at least one first fastening mechanism is a polymeric material integrated with the first layer, wherein a receiving area is disposed on an outside of the first layer and an anchor is on an inside of the first layer; a second layer having at least one second fastening mechanism, wherein the at least one second fastening mechanism is the polymeric material integrated the second layer, wherein a receiving area is disposed on an outside of the first layer and an anchor is on an inside of the first layer; and wherein the at least one first fastening mechanism has a shape that is complementary to a shape of the at least one second fastening mechanism.

In another aspect of the present invention there is a method of making a fastening mechanism comprising the steps of applying a chemical agent to a first layer of fabric; molding a first fastening mechanism from the chemical agent to a first shape; and allowing the chemical agent to cure thereby causing the chemical agent to retain the first shape; applying a chemical agent to a second layer of fabric; molding a second fastening mechanism from the chemical agent to a second shape; and allowing the chemical agent to cure thereby causing the chemical agent to retain the second shape.

In some embodiments suitable chemical agents may include but are not limited to polyurethanes, polyamides, and polypropylene, and the like or any combination thereof. In other embodiments, the chemical agent is an acetal, elastomer, urethane, or olefins. In yet other embodiments, the chemical agent may comprise more than one of the above and others not named herein, which may be the same or different categorically as any of the other components of the agent. The chemical agent may be applied as a liquid, gel, powder, emulsion, or the like or any combination thereof. It may be necessary to apply more than one chemical agent in creating the fastening mechanism.

The fastening mechanism may be formed by applying the chemical agent to the article of clothing, or other suitable material, and then placing that portion of the clothing in a mold or press to be shaped as desired. As the fastening mechanism cures, a particular shape is formed on the material. Once cured, the fastening material is at least semi-rigid in nature, but is such that it may still flex and move to some degree to interface with a second fastening mechanism and to prevent undue damage to the fastening mechanism during use. In other embodiments, the fastening mechanism may be formed from the fabric (or other material) itself. In such embodiments, the chemical agent stiffens or solidifies the fabric to a degree in a particular formation or shape thereby enabling it to mate or couple with a complementary shape.

Additionally, the fastening mechanism is preferably water resistant and heat resistant, thus enabling the clothing item or other material to be washed in a washing machine or by hand as needed and then subsequently dried. In some embodiments, the chemical or chemical agents used may have self-healing properties.

In general, the present invention succeeds in conferring the following, and others not mentioned, benefits and objectives.

It is an object of the present invention to provide a fastening mechanism that is integrated with an article of manufacture.

It is an object of the present invention to provide a fastening mechanism that permeates from an inner surface to an outer surface of at least one layer of material.

It is an object of the present invention to provide a fastening mechanism that is discreet.

It is an object of the present invention to provide a fastening mechanism that is machine and/or hand washable.

It is an object of the present invention to provide a fastening mechanism that can be used to pair articles of clothing, toys, or other suitable materials.

It is an object of the present invention to provide a fastening mechanism that is lightweight and semi-rigid.

It is an object of the present invention to provide a fastening mechanism that is inexpensive to produce.

It is an object of the present invention to provide a fastening mechanism that is at least heat resistant.

It is an object of the present invention to provide a fastening mechanism that may be used on any number of woven or non-woven materials.

It is an object of the present invention to provide a fastening mechanism that cannot be removed.

It is an object of the present invention to provide a fastening mechanism that is formed directly from the material comprising the article.

It is an object of the present invention to provide a fastening mechanism that is comfortable for the wearer.

It is an object of the present invention to provide a fastening mechanism is formed through the article of manufacture thereby forming a single article-fastening mechanism unit.

It is an object of the present invention to provide a fastening mechanism that can hold two objects either the same or different together as desired.

### BRIEF DESCRIPTION OF THE DRAWINGS

FIG. 1 is a front view of an article of clothing bearing an embodiment of the present invention.

FIG. 2 is a sectional view taken along line A-A′ as shown in FIG. 1.

FIG. 3 is a sectional view of two fabric layers adhered to one another via the present invention.

FIG. 4 is a front view of an article of clothing bearing an embodiment of the present invention.

FIG. 5 is a sectional view taken along line B-B′ as shown in FIG. 5.

FIG. 6 is a sectional view of two fabric layers adhered to one another via the embodiment of the present invention shown in FIG. 4.

FIGS. 7A-F are examples of varying embodiments of the present invention implementing various combinations of shapes, sizes, and configurations.

FIG. 8 is a flow chart outlining at least one method of making an embodiment of the present invention.

### DETAILED DESCRIPTION OF THE INVENTION

The preferred embodiments of the present invention will now be described with reference to the drawings. Identical elements in the various figures are identified, as far as possible, with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

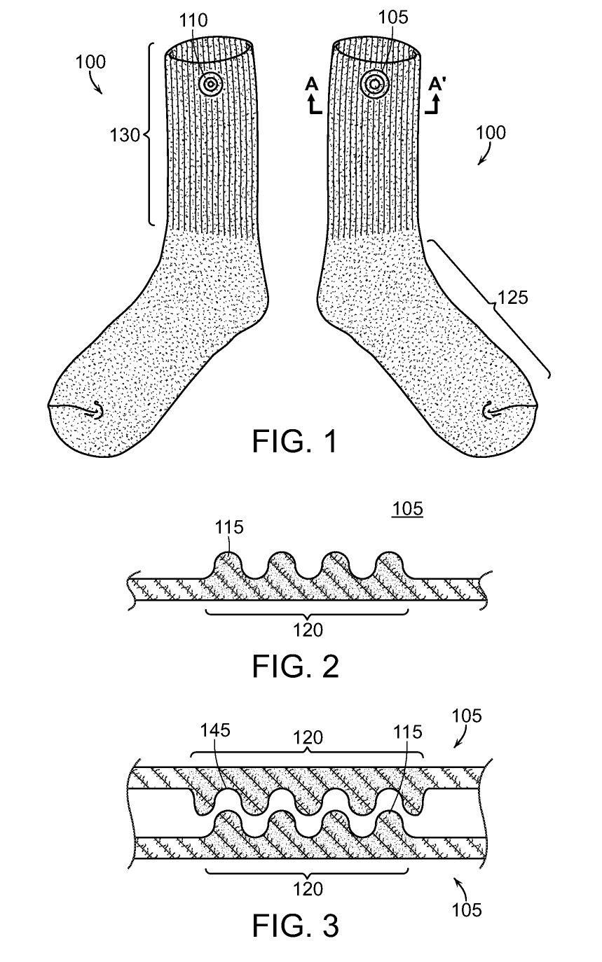

Referring now to FIG. 1, are a couple exemplary articles of clothing 100, in this case, socks. The article of clothing 100, as shown, generally has a foot portion 125 and a leg portion 130. The foot portion 125 fits over the foot/ankle area, whereas the leg portion, if present, 130 covers some part of the leg of the wearer. Depending on the style, the size of the foot portion 125 and leg portion 130 may vary or the leg portion 130 may be virtually non-existent. The first fastening mechanism 105 and the second fastening mechanism 110 are preferably formed on the leg portion 130. This prevents any discomfort a wearer may experience if the fastening mechanisms were positioned on the foot portion 125.

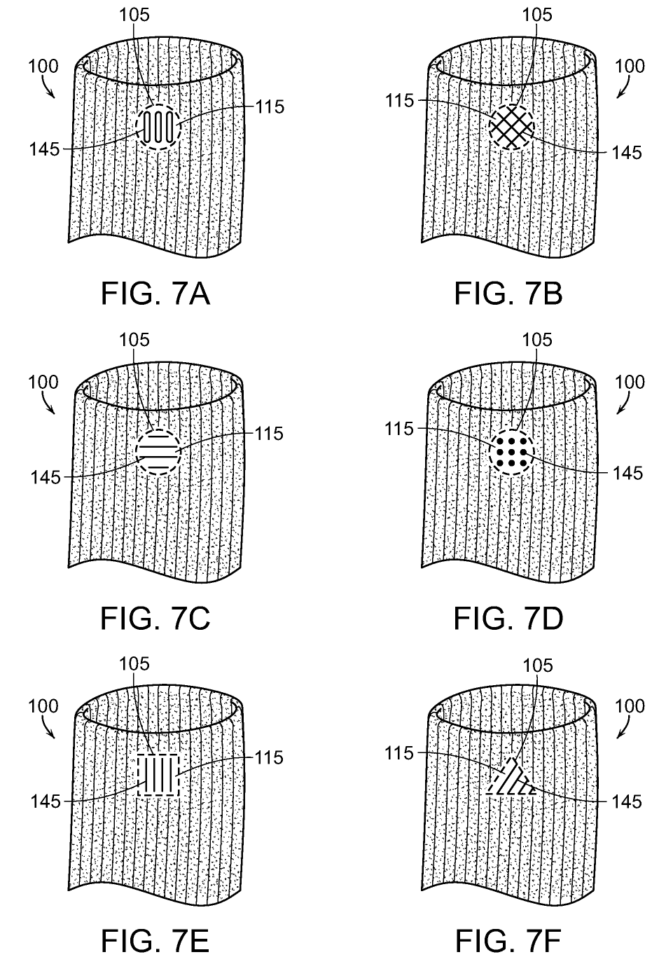

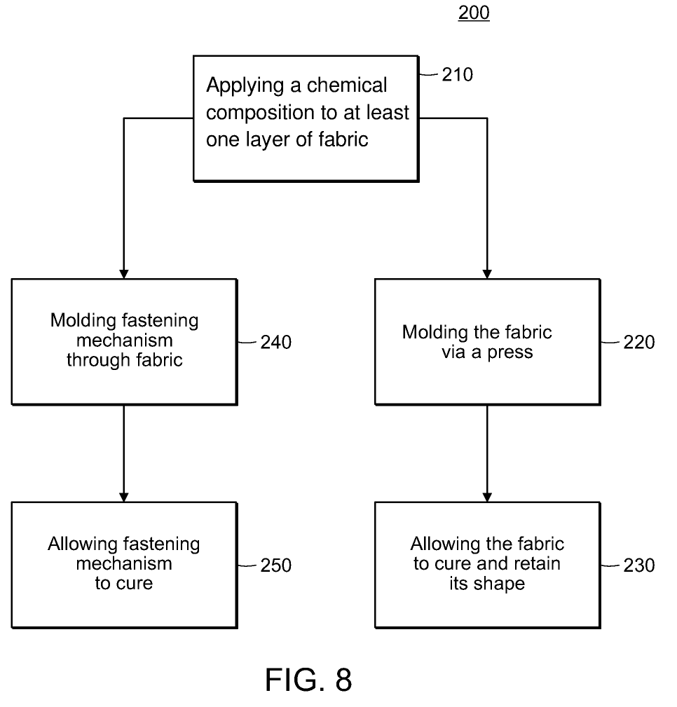

In FIG. 2, a view of one of the articles of clothing 100 is shown along line A-A′ in FIG. 1. The first fastening mechanism 105 as viewed from the side is shown as an integrated portion of the article of clothing 100. The chemically treated area or patch 120 has been shaped and cured into a particular configuration that allows for adherence or coupling to another second fastening mechanism bearing a similar, yet opposing shape. This allows the shape of the first fastening mechanism 105 to join and interlock with the shape of the second fastening mechanism 110 (see FIG. 3). In this instance, there are ridges 115 formed in the fabric that provide the surface area for adherence. The ridges 115 can be present in a number of shapes, configurations, and the like. In turn, the chemically treated area or patch 120 can be an equally varied number of shapes, configurations, and the like (see FIG. 7A-F).

FIG. 3 illustrates a potential relationship and coupling between a first fastening mechanism 105 and a second fastening mechanism 110. Two articles of clothing 100, or in some instances the same article of clothing 100, can be brought together having a first fastening mechanism 105 and a second fastening mechanism 110 disposed thereon. Each of the fastening mechanisms 105, 110 comprise chemically treated areas 120 of the article of the clothing 100.

The ridges 115 of the first fastening mechanism 105 are received in the valleys 145 of the second fastening mechanism 110 and vice versa. A user simply needs to bring a first and a second fastening mechanism 105, 110 together and provide an inward force to join. The fastening mechanisms 105, 110 should provide adequate adherence so that that are readily coupled to one another, but can be released quickly and easily when a user desires. To separate the article(s) of clothing 100, a user simply holds the article of clothing 100 and uses a force directed in opposite directions (outwardly) to disengage the fastening mechanisms 105, 110. In some embodiments, the fastening mechanism 105, 110 may comprise a button, hook, snap, clasp, and the like or a combination thereof.

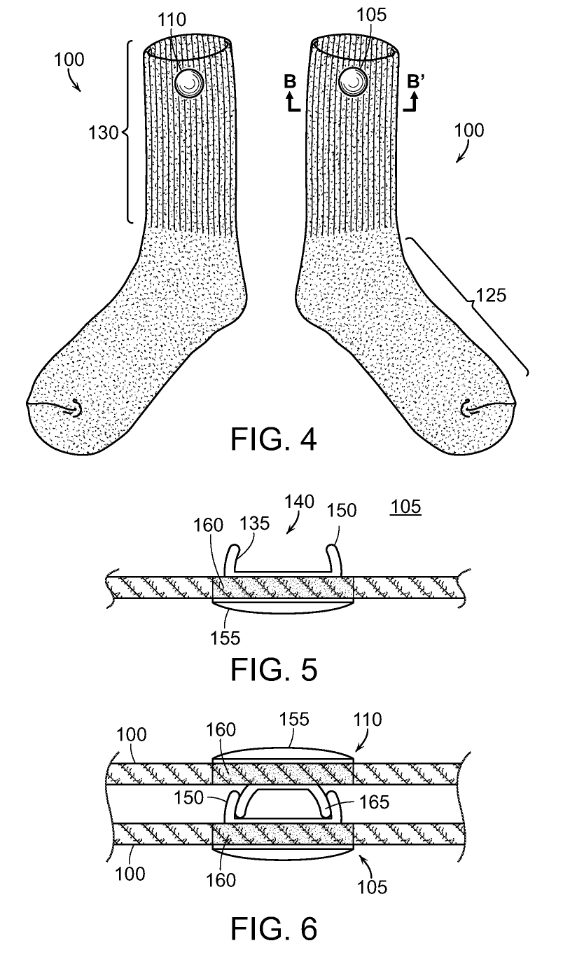

Referring to FIG. 4, there is another embodiment of the present invention as shown on an article of clothing 100. The article of clothing 100 or socks, as described above, generally has a foot portion 125 and a leg portion 130. The foot portion 125 fits over the foot/ankle area, whereas the leg portion, if present, 130 covers some part of the leg of the wearer. Depending on the style, the size of the foot portion 125 and leg portion 130 may vary or the leg portion 130 may be virtually non-existent. The first fastening mechanism 105 and the second fastening mechanism 110 are preferably formed on the leg portion 130. This prevents any discomfort a wearer may experience if the fastening mechanisms 105, 110 were positioned on the foot portion 125.

Here, the first fastening mechanism 105 and the second fastening mechanism 110 are formed from a material that has been applied, under pressure, to the article of clothing 100. This allows the chemical agent comprising the fastening mechanisms to permeate through and integrate with the fibers of the article of clothing 100 and thus the article of clothing 100 as a whole. This creates a single “unit” between the two structures such that the fastening mechanisms cannot be removed from the article of clothing or other item without destroying the item itself.

Referring now to FIGS. 5 and 6, there is a sectional side view along line B-B′ demonstrating an embodiment of the present invention, as well as a sectional side view demonstrating a coupling of such an embodiment, respectively. The first fastening mechanism 105, as shown in FIG. 5, has a first ridge 150 with an interior of the first ridge 150 defining a receiving area 140. The inner surface 135 of the first ridge 150 defines the mating surface, or surface which interfaces with that of the second fastening mechanism 110 as shown in FIG. 6.

The first fastening mechanism 105, in this embodiment, has a shape that is narrower at the top, or opening, than at the base which is in proximity to the fabric layer itself. This narrow-wide configuration allows for a complementary fastening mechanism to be inserted into the wider receiving area 140 and then be retained by the first ridges 150. As shown, a chemical agent comprising the first fastening mechanism 105 permeates through and is integrated with the fibers forming a chemical-fiber matrix 160. On an inner surface of the article there is an anchor 155, which may be flush with the article's inner surface or may protrude to some degree. The anchor 155 is formed from the employed methodology, in some instances, and may not be present in all embodiments. Further, the “anchor” may not in fact anchor the fastening mechanism thereon, as that interaction occurs, in some embodiments, primarily in the chemical-fiber matrix 160.

As shown in FIG. 6, a second fastening mechanism 110 has been coupled with the first coupling mechanism 105. The second ridges 165 are in the receiving area 140 of the first fastening mechanism 105. The fit between the first ridges 150 and the second ridges 165 may be described as an interference fit. The amount of interference between the first ridges 150 and the second ridges 165 defines the “tightness” of the coupling. In embodiments of the present invention, the interference between the first and the second fastening mechanisms may be about 0.0001 to 0.0040 inches and more preferably about 0.0001 to about 0.0020 inches. The material selected to comprise the fastening mechanisms may be selected to allow the mechanisms to deform as necessary during the coupling and removal (or separation) processes.

Either of the fastening mechanisms can serve as the male fastening mechanism or the female fastening mechanism and may comprise virtually any variety of shape, ridge/valley configuration, and the like. Further, the fastening mechanisms may vary in color to match or contrast or otherwise be aesthetically pleasing on a particular article. In some embodiments, the fastening mechanism is shaped in the form of a logo such as a sports logo, sports team logo, business logo, and the like. Further, in some embodiments, the fastening mechanism(s) may comprise a button, hook, snap, clasp, and the like or a combination thereof.

FIGS. 7A-F show various example configurations and shapes of first fastening mechanisms 105 on an article of clothing 100. The second fastening mechanism (not shown) may bear the same or a different shape. The first and the second fastening mechanisms can be coupled regardless or shape as long as the ridges and valleys can be aligned. The article of clothing 100 in this representation is of the upper half, or cuff area, of a sock.

In each of FIGS. 7A-F, the darkened areas signify recessed areas or valleys 145 or receiving areas 140 (see FIG. 5) within the first fastening mechanism 105 and the lighter areas or ridges 115 signify level or elevated areas of the first fastening mechanism 105.

In FIG. 7A, the first fastening mechanism 105 is shown having a circular form. In FIGS. 7B-D the first fastening mechanism 105 is shown having a generally circular appearance with varied patterns of ridges 115. The ridges 115 may have a crosshatch pattern as shown in FIG. 4B or a dimpled pattern as shown in FIG. 7D. FIGS. 7A and 7C exemplify ridges 115 generally parallel to one another in generally vertical or horizontal patterns.

FIGS. 7E and 7F demonstrate a couple different shapes of the first fastening mechanism 105. The first fastening mechanism 105 may bear the shape of a quadrilateral as shown in FIG. 7E or may be more triangular in shape such as in FIG. 7F. Each of the first fastening mechanisms 105 are shown having generally parallel ridges, but with different overall shapes. The ridges 115 may also be in any previous configuration discussed or others not shown.

Referring now to FIG. 8, there is a method 200 of making a fastening mechanism as described above. In a box 210, a chemical agent is applied to at least one layer of fabric. The size of the area to be treated depends on the article of clothing associated with the fabric and the size and shape as well as the texture of the fastening mechanism to be formed.

Once the area of fabric is saturated with the chemical agent, the treated area is molded when a press is applied to the treated area in box 220. The press may be a machine based press that employs hydraulics or other mechanisms to exude a pressure upon the treated area of fabric. The press has a die that has a particular shape and ridged configuration. The press forms the fabric layer to conform to this shape.

In a box 230, the treated fabric area is allowed to cure. Depending on the chemical agent used, the press may apply heat, cold, blown air, electric shock, vibrations, and the like or any combination thereof to aid in the curing process. In some embodiments, thermoplastic or thermoset processes are implemented. Additionally, the chemical agent may enable a press process that is almost instantaneous and allows the fabric to retain the pressed shape while curing. In some instances, the type of fabric may help to retain a particular shape once pressed into the fabric. A coating may be applied to the cured fabric to provide additional protection, coloring, and the like or a combination thereof. Since the fastening mechanism is formed of the fabric comprising the article of clothing, it cannot become separated from the article of clothing.

Alternatively, after the chemical agent is applied to at least one layer of fabric or other suitable material in box 210, the methodology may move to box 240. In box 240, a fastening mechanism is molded through and integrated with the fabric or other similar material. This is accomplished via a machine press using about 200 psi to about 1000 psi to cause the chemical agent to sufficiently permeate the material. The exact psi requirements may depend on the chemical agent being used and the fabric or other material to be penetrated by the chemical agent. In some instances, a hole must first be made in the fabric or other material to facilitate the integration of the chemical agent.

In a box 250, the fastening mechanism is allowed to cure. Depending on the chemical agent used, the press may apply heat, cold, blown air, electric shock, vibrations, and the like or any combination thereof to aid in the curing process. In some embodiments, thermoplastic or thermoset processes are implemented. Additionally, the chemical agent may enable a press process that is almost instantaneous and allows the fabric to retain the pressed shape while curing. In some instances, the chemical agent is allowed to cure within the mold of the press whereas in other scenarios the fastening mechanism is removed and allowed to cure elsewhere. Any of the aforementioned curing strategies may also be supplied outside of the press if needed or desired.

This creates a fastening mechanism that exists on, for example, both side of the fabric. There may be an anchor located in the inside surface of the fabric and the ridges are located on an outer surface of the fabric. In some embodiments, the may be no anchor and the fastening mechanism resides on only one side of the article of manufacture or fabric material itself. The fastening mechanism is a single piece that is integrated and formed with the fabric material. The intention is that little to no structural integrity is lost in the fabric material and the fastening mechanism is wholly integrated therewith preventing removal of the fastening mechanism less destroying the item to which it is coupled.

One such methodology, as described above, may be accomplished using an ARBURG Allrounder injection molding machine (e.g. ARBURG Allrounder V) or similarly situated piece of equipment (e.g. vertical injection molding machine). Such a machine has a fixed, vertical clamping unit with a fixed mold platen located at either of the top or bottom of the machine. The machine settings for injection molding one embodiment of the present invention are contained in the table below.

TABLE 1
TEMPERATURES

| | | |
|---|---|---|
| Nozzle Temperature: | 350 | F. |
| Front Temperature: | 340 | F. |
| Middle Temperature: | 340 | F. |
| Rear Temperature: | 330 | F. |
| Additional Temperature: | N/A | F. |
| Hot Sprue Temperature: | N/A | F. |
| Barrel Water: | 2.0 | Flowmeter Setting |

SCREW SPEED

| Screw RPM'S: | 100 | | Machine Setting: | 1.3 | |
|---|---|---|---|---|---|
| Shot Size - B27: | 12.3 | | Suckback - B29: | 17.2 | |
| Retract Setting - B28: | 18.5 | | 2^{nd} Stage Injection - B26: | 18.5 | |
| Retract Distance: | ½ | in | Cushion: | 5 | mm |

INJECTION PRESSURE

| | | | | | |
|---|---|---|---|---|---|
| Stage 1: | 550 | psi | Stage 2: | 300 | psi |

| Back Pressure: | 0 | psi | Injection Speed: | 2.0 | |
|---|---|---|---|---|---|
| Clamp Limit: | 3/4 | | | | |
| | (# - of additional turns) | | | | |
| Mold Open Daylight: | 6.0 | in | | | |
| Clamp Closing Speed: | 1.5 | | Clamp Opening Speed: | 2.0 | |
| Clamp Damper: | 1-½ | in | Ejector Count B38: | 0 | |
| Ejection Setting: | N/A | cm | Ejection Distance: | 0 | in |

| Forward Eject Speed: | N/A | | Backward Eject Speed: | N/A |
|---|---|---|---|---|
| Knack Out Rods: | N/A | in | Operation Mode: | S |

| | | |
|---|---|---|
| Cycles Before Reset: | 0 | (A-Automatic, |
| Injection Configuration: | S | S-Semi, |
| | (S-Standard, | M-Manual) |
| | P-Parting Line) | |

TIMERS AND SETUP TIME

| Injection Time - T1: | 1.2 | sec |
|---|---|---|
| Hold Time - T2: | 1.0 | sec |
| Cooling Time - T3: | 5.0 | sec |
| Recycle Time - T4: | 0.1 | sec |
| Injection Delay Time - T5: | 0.5 | sec |
| Machine Movement Time: | sec | |
| Operator Assistance Time: | sec | |
| Total Cycle Time: | 0 | sec |
| Time Required To Set Up: | 2.0 | hrs |

In order to use the ARBURG or other vertical injection molding machine, fabric articles, such as those listed herein, are loaded into the mandrels. The mandrels may maneuver around a racetrack or raceway into the molding area. Once in the molding area, the mandrels are moved into at least one mold mounted between the platens of the injection molding machine. As the mold closes, the polymer is injected under high pressure (see at least above table) through the weave of the fabric and into the mold cavities. Thus, the fastening mechanism can be formed on at least one of and, in some instances, both side of the fabric.

The treated fabric area is thereby encapsulated in the fastening mechanism. The polymer comprising the fastening mechanism is held under pressure until the polymer is solidified using conventional methodologies. The mold then opens and the mandrel moves along the raceway to the unloading station where the fastening mechanism/fabric item combination is removed from the mandrel.

The fastening mechanism(s) described and taught in FIGS. 1-8 has been described as being applicable to socks and pairs thereof. However, any article of clothing may be suitable for usage with the present invention and its embodiments. This includes, but is not limited to, pants, shirts, vests, belts, ties, shorts, suits, hats, undergarments, gloves, baby's clothes, and the like or any combination thereof. These same embodiments may be readily applied to other materials and objects such as bags, backpacks, tarps, tents, and any other item that may require an adherence of part(s) to one another or to a secondary object. Additionally, toys may employ the fastening mechanisms described herein. Further, the materials comprising such articles for which the present invention may be formed and integrated includes but is not limited to woven or unwoven fabric, cloth, terrycloth, woven or woven fibers of wool, flax, cotton, and/or yarn, mineral textiles, denim, elastomeric fibers/fabrics, and synthetic textiles including but not limited to nylon, polyester, and/or acrylic, or any combinations thereof.

In some instances, there are additional indicia present on the article of clothing or similarly situated material to aid a user in finding the fastening mechanism present thereon. For example, if a user is attempting to pair socks together that are dark in color or attempting the same in low light conditions, it may be difficult to find the corresponding fastening mechanisms on each of the socks.

Therefore, the fastening mechanisms may be colored in a way to highlight their position on the article of clothing. Such a coloring may be applied after the fastening mechanism has been formed and cured from the article of fabric or may be applied to the chemical agent to be applied to the article of fabric. Any artificial or natural coloring agents should be chosen to be non-reactive with the particular chemical agent chosen for the fastening mechanism as well as being at least water and heat resistant. Alternatively, the article of clothing may be colored in a way to provide guidance to the user as to the location of the fastening mechanism. This includes various designs such as outlining, arrows, or wording such as left or right to identify the article of clothing and thereby the position of the fastening mechanism. Further, as noted above, the fastening mechanism may comprise a logo such as a company or sports teams.

The chemical agent used to treat the fabric is preferably a polymeric material that is resistant to chemical interactions (non-reactive), heat, and water. The chemical agent, once cured, is preferably a semi-rigid solid that retains some flexibility to provide overall safety and comfort to the wearer.

Suitable chemical agents may include but are not limited to polyurethanes, polyamides, and polypropylene, and the like or any combination thereof. In some embodiments, the chemical agent is an acetal, elastomer, urethane, or olefins. In some embodiments, the chemical agent may comprise more than one of the above and others not named herein, which may be the same or different categorically as any of the other components of the agent. The chemical agent may be applied as a liquid, gel, powder, emulsion, or the like or any combination thereof. It may be necessary to apply more than one chemical agent in creating the fastening mechanism.

Further, it may be preferable to employ a self-healing material to help stymie damage to the fastening mechanism as the article of clothing is worn, cleaned, used, and flexed. Self-healing materials have the innate ability to repair damage cause by mechanical stresses and strains (i.e. flexing) over time. This may extend the lifespan of such fastening mechanisms integrated into the articles of clothing. The chemical agents may be applied singularly or in conjunction with another chemical agent selected at least for the properties named above as well as their interactions with any other chemical agents in an applicable composition. In some cases, a first chemical may be applied and allowed to cure and then a second chemical coating may be applied resulting in separate, distinct layers which serve to form the fastening mechanism.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A fastening system comprising:
a first layer having at least one first fastening mechanism,
wherein the at least one first fastening mechanism comprises a first patch of the first surface,
wherein the first patch is treated with a chemical agent causing the at least one first fastening mechanism to be formed from the first layer; and
a second layer having at least one second fastening mechanism,
wherein the at least one second fastening mechanism comprises a second patch of the second layer,
wherein the second patch is treated with the chemical agent causing the at least one second fastening mechanism to be formed from the second layer; and
wherein the at least one first fastening mechanism has a shape that is complementary to a shape of the at least one second fastening mechanism.

2. The system of claim 1 wherein the first layer and/or the second layer comprise at least two layers of woven or non-woven material.

3. The system of claim 1 wherein there are about one to about ten fastening mechanisms on the first surface and/or the second surface.

4. The system of claim 1 wherein the chemical agent stiffens at least one first fastening mechanism and the at least one second fastening mechanism into a first shape and a second shape.

5. The system of claim 1 wherein the first layer and the second layer are present on the same or different article of clothing.

6. The system of claim 5 wherein the article of clothing is a pair of socks, pants, undergarments, gloves, hat, baby's clothes, or shirt.

7. The system of claim 1 wherein the chemical agent is a polymeric material.

8. A fastening system comprising:
a first layer having at least one first fastening mechanism,
wherein the at least one first fastening mechanism is a polymeric material integrated with the first layer,
wherein a receiving area is disposed on an outside of the first layer and an anchor is on an inside of the first layer;
a second layer having at least one second fastening mechanism,
wherein the at least one second fastening mechanism is the polymeric material integrated the second layer,
wherein a receiving area is disposed on an outside of the first layer and an anchor is on an inside of the first layer; and
wherein the at least one first fastening mechanism has a shape that is complementary to a shape of the at least one second fastening mechanism.

9. The system of claim 8 wherein the at least one first fastening mechanism and the at least one second fastening mechanism are insoluble in water.

10. The system of claim 8 wherein the at least one first fastening mechanism and the at least one second fastening mechanism are resistant to heat.

11. The system of claim 8 wherein the at least one first fastening mechanism and the at least one second fastening mechanism are chemically non-reactive.

12. The system of claim 8 wherein the chemical agent is an acetal, nylon, elastomer, urethane, olefin, polyurethane, polypropylene, polyamide, or a combination thereof.

13. The system of claim 8 wherein the first shape has an interference with the second shape of about 0.0001 to about 0.0020 inches.

14. The system of claim 8 wherein the at least one first fastening mechanism or the at least one second fastening mechanism is a snap, button, or hook.

15. A method of making a fastening mechanism comprising the steps of:
applying a chemical agent to a first layer of fabric;
molding a first fastening mechanism from the chemical agent to a first shape; and
allowing the chemical agent to cure thereby causing the chemical agent to retain the first shape;
applying a chemical agent to a second layer of fabric;
molding a second fastening mechanism from the chemical agent to a second shape; and
allowing the chemical agent to cure thereby causing the chemical agent to retain the second shape.

16. The method of claim 15 wherein the first shape and the second shape are complimentary.

17. The method of claim 16 wherein the first shape has an interference with the second shape of about 0.0001 inches to about 0.0020 inches.

18. The method of claim 15 wherein the first fastening mechanism and the second fastening mechanism are machine pressed.

19. The method of claim 15 wherein the first fastening mechanism and the second fastening mechanism are formed from the first layer and the second layer of fabric.

20. The method of claim 15 wherein the first fastening mechanism and the second fastening mechanism are formed from a permeation of the chemical agent through the first layer and the second layer of fabric.
